(19) United States
(12) Patent Application Publication
(10) Pub. No.: US 2022/0356420 A1
(43) Pub. Date: Nov. 10, 2022

(54) NON-SILICONE VEGETABLE OIL BASED ANTI-FOAM COMPATIBLE WITH CROSS-FLOW FILTRATION

(71) Applicant: Kerry Group Services International Limited, Co. Kerry (IE)

(72) Inventors: Shekhar Umakantrao KADAM, Co. Kildare (IE); Jacques GEORIS, Couthuin (BE); Jonathan DOYLE, Co. Cork (IE); Eoin LALOR, Co. Kildare (IE); Daragh CUSKELLY, Co. Kildare (IE)

(73) Assignee: Kerry Group Services International Limited, Co. Kerry (IE)

(21) Appl. No.: 17/737,353

(22) Filed: May 5, 2022

Related U.S. Application Data
(60) Provisional application No. 63/186,437, filed on May 10, 2021.

(51) Int. Cl. C12C 11/11; A23L 29/10

(52) U.S. Cl. CPC C12C 11/11; A23L 29/10

(57) ABSTRACT

A method of processing a liquid including adding an antifoam to a process liquid, and after adding the antifoam, continuously feeding the process liquid through one or more cross-flow filter membrane configured for cross-flow filtration, wherein the antifoam includes a mixture of (A) a vegetable oil and (B) an organic emulsifier or surfactant. The antifoam may, for example, not contain silicone.

### FIELD OF THE DISCLOSURE

The present disclosure relates generally to methods of using a non-silicone antifoam formulation based on natural vegetable oils that may, for example, be particularly useful for achieving efficient and sustainable cross-flow filtration. In some aspects, the present disclosure relates to adding the antifoam formulation during fermentation in a conventional beverage manufacturing process, such as a conventional process for making beer or wine, but the methods apply generally to all liquid processing where foaming may be an issue and/or where cross-flow filtration is used after a de-/anti-foaming process, particularly when using a polymeric cross-flow membrane (and more particularly when using a polyethersulfone (PES) cross-flow membrane).

### BACKGROUND OF THE DISCLOSURE

Foaming, such as may be caused during a fermentation process, can be controlled by the addition of a foam inhibitor or antifoam. A typical antifoam formulation is based on silicone compounds (which are synthetic products having a siloxane structure). In a batch process, antifoams are typically added batchwise when needed, such as during wort boiling, fermentation, or wherever there is excessive foaming in liquid processing.

While silicones may be approved for use in food manufacturing generally, and while silicones may be deemed safe, there is an increasing demand by beverage manufactures, particularly brewers, for the development of alternative antifoam products based on natural materials. To this end, alternative antifoams are known in the art.

For example, WO 2013/021177, which is incorporated herein by reference in its entirety, discloses an antifoam containing an extract of a beer brewing material or brewing-related material obtained by extracting the material with carbon dioxide or an organic solvent, wherein the material may be at least one material selected from hops, yeast, rice and brewing-related cereals, and the brewing-related cereal may be selected from barley, wheat, millet, spelt and oats.

U.S. Pat. No. 4,339,466, which is incorporated herein by reference in its entirety, discloses an antifoam for reducing foaming during fermentation that is produced by extracting ground malt with an ethanol solution having an ethanol concentration in excess of 75% to produce an ethanolic extract, separating the ethanolic extract from the ground malt and concentrating the ethanolic extract to obtain the antifoaming agent.

GB2444359, which is incorporated herein by reference in its entirety, discloses an antifoam containing mixture of hard resins, lipids, and waxes that are obtainable by removing alpha acids and essential oils and, optionally, beta acids from a solvent extract of hops. GB '359 discloses that the mixture is the residue obtained by extraction of hops with carbon dioxide or other solvents, such as ethanol, followed by extraction of alpha acids, beta acids, and essential oils from the whole hop extract.

One limitation of these alternative antifoams is that they have been found to be less efficient than silicone antifoams. Another limitation is that some of these alternative antifoams can be difficult to use and/or may separate out during storage. Thus, there remains an ongoing need for an alternative antifoam formulation having sufficient efficiency that is also easy to use.

In addition, the brewing industry has become increasingly concerned about conserving natural resources and producing “green” products. This has led to the adoption of cross-flow filtration (also known as tangential flow filtration or TFF). This is because, for example, cross-flow filtration promises to provide a bright and clear product with consistent qualities, while avoiding the waste inherent to the conventional use of filter aids. The use of cross-flow filtration can also provide conservation of water and reduction in required energy, which are also factors driving the commercial adoption of cross-filtration. Further, the use of cross-flow filtration can also provide a high quality filtered product having organoleptic stability. Further, as compared to conventional filtration used when brewing beer, cross-flow filtration can also be automated.

In cross-flow filtration, a liquid feed is continuously recirculated tangentially to a cross-flow filter membrane surface. The purified liquid passes through the cross-flow membrane as filtrate or permeate, while suspended solids in the feed/process fluid, which are too large to pass through the pores of the cross-flow membrane, are retained in the increasingly concentrated retentate stream. The cross-flow process is designed such that the retained solids do not build up on the cross-flow membrane surface but are washed/swept away from the cross-flow membrane surface by the flow of the process liquid at right angles to the filtration direction (tangential motion of the bulk of the process fluid). However, cross-flow membranes can become slowed blocked over time, which requires time consuming physical and/or chemical cleaning, because it can be difficult for cleaning agents to reach all sites of contamination.

Conventional cross-filtration systems may contain a plurality of ceramic or polymeric modules or filter elements. Fouling of the cross-flow membranes can result in substantial downtime for cleaning and/or replacement procedures, which may result in substantial lost profits and increased costs.

In some cases, the use of a silicone-based antifoam in brewing fermentation processes where cross-flow filtration is used has been found to cause fouling or scaling of the cross-flow filter membranes. The fouling has been particularly problematic when using polyethersulfone (PES) based cross-flow membranes, which is a conventionally used membrane material for the cross-flow filtration used in fermentation processes. Without being bound by any theory, fouling of the cross-flow membranes happens due to a chemical interaction between silicone and PES.

Such fouling may also be a problem when using ceramic cross-flow membranes and other types of polymeric filter membranes, such as, for example, polysulfone (PS), modified polyethersulfone (mPES), mixed ester (ME), and mixed cellulose ester (MCE).

Accordingly, there remains a strong need for a non-silicone antifoam that is based on naturally-sourced ingredients; delivers efficient and sustainable cross-flow filtration; has no sensory impact on the final food product (e.g., a beverage, such as beer or wine, or other liquid); has a similar or better cost-in-use to conventional antifoams; and has similar or better foam inhibition as conventional silicone-based antifoams.

### SUMMARY OF THE DISCLOSURE

The present disclosure provides, for example, an antifoam that replaces silicone with natural components, such as vegetable oils and organic emulsifiers, which have the function of destroying foam generated during fermentation or another liquid process generating foam.

The antifoam of the present disclosure can be configured, for example, to deliver efficient and sustainable cross-flow filtration; have no sensory impact on the final food product (e.g., a beverage, such as beer or wine, or other liquid); have a similar or better cost-in-use to conventional antifoams; and have similar or better foam inhibition as conventional silicone-based antifoams.

The antifoam of the present disclosure has a composition that may be configured, for example, so as not to foul the cross-flow membrane when the process fluid contacted with the antifoam is subjected to cross-flow filtration.

When used in a process for brewing beer, the antifoam of the present disclosure can, for example, be separated from product-to-be-filtered (e.g., beer) before filtration and can maintain final beer foam stability.

In one embodiment, the antifoam of the present disclosure contains a mixture of a (A) vegetable oil, and (B) an organic emulsifier or surfactant.

In some aspects, the antifoam does not contain any silicone (e.g., about 0.0 wt %) and/or no silicone is added to the product-to-be filtered (e.g., beer). In some aspects, an amount of silicone in the antifoam is less than about 5.0 wt %, less than about 1.0 wt %, less than about 100 ppm, less than about 10 ppm, or less than about 1 ppm.

In some aspects, water may not be added as part of formulation; however, one would understand that water may be included in the composition as an inherent component and/or impurity of one or more of the above ingredients.

In some aspects, a weight ratio of the vegetable oil in the antifoam of the present disclosure may be, for example about 5.0 to about 70.0 wt %; about 20.0 to about 60.0 wt %; or about 40.0 to about 50.0 wt %.

In some aspects, the weight ratio of the vegetable oil may be, for example, 7.5 wt % or higher, 10.0 wt % or higher, 15.0 wt % or higher, 20.0 wt % or higher, 25.0 wt % or higher, 30.0 wt % or higher, 35.0 wt % or higher, 40.0 wt % or higher, 45.0 wt % or higher, 50.0 wt % or higher, 55.0 wt % or higher, 60.0 wt % or higher, or 65.0 wt % or higher, or may be, for example, 65.0 wt % or lower, 60.0 wt % or lower, 55.0 wt % or lower, 50.0 wt % or lower, 45.0 wt % or lower, 40.0 wt % or lower, 35.0 wt % or lower, 30.0 wt % or lower, 25.0 wt % or lower, 20.0 wt % or lower, 15.0 wt % or lower, 10.0 wt % or lower, or 7.5 wt % or lower.

In some aspects, the vegetable oil for use in the antifoam of the present disclosure can be any known vegetable oil. Examples include oils extracted from seeds (e.g., “oilseed fatty acids”) or from other parts of vegetables and fruits.

Specific examples of a vegetable oil that may be used in the antifoam include soybean oil, palm oil, rice bran oil, sunflower oil, olive oil, coconut oil, rapeseed oil, canola oil, peanut oil, cottonseed oil, corn oil, linseed oil, safflower oil, sesame oil, hazelnut oil, açaí palm oil, avocado oil, brazil nut oil, cashew oil, chia seed oil, cocoa butter oil, flaxseed oil, hemp seed oil, pecan oil, walnut oil, and blends thereof.

In some aspects, the vegetable oil component may be selected to include, for example, fatty acid chain lengths below C12. In one aspect, over 10 weight percent of the vegetable oil may include fatty acid chain lengths below C12.

In some aspects, the vegetable oil component may be selected to include saturated fatty acids, monosaturated fatty acids, polysaturated fatty acids, or combinations thereof.

In some aspects, the vegetable oil component of the antifoam can be selected for the purpose of achieving a specific melting point, such that, for example, the vegetable oil component will essentially become a solid during a conventional liquid processing step and/or during an additional process step of lowering the temperature below the melting point of the vegetable oil component.

In some aspects, a weight ratio of the organic emulsifier or surfactant in the antifoam of the present disclosure may be, for example, about 5.0 to about 60.0%; about 10.0 to about 40.0 wt %; or about 15.0 to about 25.0 wt %.

In some aspects, the weight ratio of the organic emulsifier or surfactant may be, for example, 7.5 wt % or higher, 10.0 wt % or higher, 15.0 wt % or higher, 20.0 wt % or higher, 25.0 wt % or higher, 30.0 wt % or higher, or 35.0 wt % or higher, 40.0 wt % or higher, 45.0 wt % or higher, 50.0 wt % or higher, or 55.0 wt % or higher, or may be, for example, 55.0 wt % or lower, 50.0 wt % or lower, 45.0 wt % or lower, 40.0 wt % or lower, 35.0 wt % or lower, 30.0 wt % or lower, 25.0 wt % or lower, 20.0 wt % or lower, 15.0 wt % or lower, 10.0 wt % or lower, or 7.5 wt % or lower

In some aspects, the organic emulsifier or surfactant can be any known emulsifier or surfactant obtained from a natural source. Example organic emulsifiers and surfactants include mustard, soy and egg lecithin, mono- and diglycerides, polysorbates, carrageenan, guar gum, polyglycerol esters, stearoyl lactylates, propylene glycol, propylene glycol esters, sucrose esters, saccharide fatty acid esters, milk proteins, wheat glutens, gelatins, prolamines, soy protein isolates, starches, acetylated polysaccharides, alginates, carrageenans, chitosans, inulins, long chain fatty acids, waxes, agar, alginates, glycerol, gums, poloxamers, monosodium phosphates, monostearate, fatty acid methyl esters (e.g., methyl stearate, methyl palmitate, methyl palmitoleate (cis-9)), and blends thereof. Other examples include, for example, sorbitan monododecanoate, polyoxyethylene 20 sorbitan monostearate, sorbitan mono-9-octadecenoate, 9-octadecenoic acid, and blends of two or more thereof.

In some aspects, the antifoam may optionally additionally contain silica (such as, for example, hydrophobic silica and/or hydrophilic silica) in an amount, for example, of about 0.010 wt % to about 40.0 wt %, or about 2.0 wt % to about 30.0 wt %, or about 15.0 wt % to about 25.0 wt %. In some aspects, the antifoam does not contain any silica (e.g., an amount of about 0.0 wt %).

In some aspects, the antifoam of the present disclosure can be obtained by mixing, in any order, the (A) vegetable oil and the (B) organic emulsifier or organic surfactant. The antifoam can be prepared in advance and stored. The components of the antifoam could also be dosed individually during a liquid processing step.

In one embodiment, the present disclosure provides a method of filtering a liquid containing the antifoam and/or a liquid which has been contacted with the antifoam.

In some aspects, the method of filtering is cross-flow filtration.

In some aspects, the liquid to be filtered by the method (or process liquid) is any liquid subject to excessive foaming during liquid processing.

In some aspects, the liquid to be filtered by the method is any liquid that has been mixed with the antifoam of the present disclosure.

In some aspects, the liquid to be filtered by the method is a beverage.

In some aspects, the beverage to be filtered by the method is beer, wine, or other fungal or bacterial fermented beverages such as, for example, kombucha and iambic beers.

In some aspects, the method includes adding an amount (or dose) of the antifoam during a step in the production of beer (in this aspect, the liquid to be filtered would be beer or an intermediate in the beer brewing process) followed by filtering the beer using cross-flow filtration. For example, the beer brewing step can be any step where an antifoam is conventionally added. In some aspects, the dosing point can be during a step of wort boiling, during fermentation, during any other step that may result in an excess of foam, and/or any other step that may benefit from the addition of the antifoam.

In some aspects, the method includes adding, for example, about 2.0 ppm to about 500.0 ppm of the antifoam in the liquid to be fermented. In some aspects, the dosage of the antifoam may be about 2.0 ppm to about 500.0 ppm; about 5.0 ppm to about 250.0 ppm; or about 10.0 ppm to about 100.0 ppm in the liquid to be fermented.

In some aspects, cross-flow filtration includes continuously feeding or recirculating the liquid to be filtered (or process liquid) through one or more cross-flow membrane, wherein purified liquid passes through the cross-flow membrane as filtrate or permeate, while suspended solids in the feed liquid, which are too large to pass through the pores of the cross-flow membrane, are retained in the increasingly concentrated retentate.

In some aspects, the cross-flow membrane is made from or composed of, for example, a ceramic material or a polymeric material.

In some aspects, the cross-flow membrane is composed of, for example, polyethersulfone (PES), polysulfone (PS), modified polyethersulfone (mPES), mixed ester (ME), mixed cellulose ester (MCE), or blends thereof. In some aspects, a pore size of the cross-flow membranes can range, for example, from about 0.10 μm to about 10.0 μm for microfiltration and about 0.0010 μm to about 0.10 μm for ultrafiltration.

Additional features and advantages of the present disclosure are described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE FIGURES

Any figures contained herein are provided only by way of example and not by way of limitation.

FIG. 1 is a chart showing an effect of different formulations on antifoam efficiency in Example 1.

FIG. 2A is a chart showing an effect of dose response of AFV3 on % increase in foam height in beer fermentation in Example 2.

FIG. 2B is a chart showing an effect of antifoam dose response on foam stability of finished beer in Example 2.

FIG. 3 is a chart showing an effect of antifoam on cross-flow filtration using crossflow advanced and 0.45 μm PES membrane in Example 3.

### DETAILED DESCRIPTION OF THE DISCLOSURE

Before the present compositions, methods, and methodologies are described in more detail, it is to be understood that the disclosure is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “a glyceride” includes one or more glycerides, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this disclosure belongs. Any methods and materials similar or equivalent to those described herein may be used in the practice or testing of the disclosure, as it will be understood that modifications and variations are encompassed within the spirit and scope of the instant disclosure.

Unless otherwise stated, each range disclosed herein will be understood to encompass and be a disclosure of each discrete point and all possible subranges within the range.

As used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term, and “substantially” and “significantly” will mean plus or minus >10% of the particular term. “Comprising” and “consisting essentially of” have their customary meaning in the art.

In embodiments, the present disclosure provides mixing the components of the antifoam and/or obtaining the antifoam; adding the antifoam to a process liquid; and subjecting the process liquid to cross-flow filtration.

As shown in the Examples below, the antifoam provides, for example, one or more of the advantages described above compared to the use of a conventional silicone-based antifoam.

In addition, the antifoam provides, for example, no sensory impact on the final food product (e.g., a beverage, such as beer or wine, or other liquid).

### EXAMPLES

In the following, although embodiments of the present disclosure are described in further detail by means of Examples, the present disclosure is not limited thereto.

### Example 1

Example 1 shows the effect of different antifoams on fermentation processes.

### Methodology

Antifoam Solution Preparation and Dosing

The following formulations were tested for antifoam efficiency:
AFS: water 65 wt %, silicone 20 wt %, and organic emulsifiers 15 wt %;
AFV1: water 60 wt %, silicone 25%, organic emulsifiers 15 wt %;
AFV2: polyalkyl glycol 90 wt %, and propyl alcohol 10 wt %; and
AFV3: rapeseed oil 45 wt %, 9-octadecenoic acid 35 wt %, sorbitan monododecanoate 15 wt %, and other organic emulsifiers 5 wt %.

A 1% (w/v) solution of each antifoam in water was obtained and recirculated vigorously for 30-60 mins. The antifoam solution was added to beer within 1-2 hours, as per dosage requirement of the trial. The beer was fermented for 4 to 5 days at room temperature (RT), i.e., about 20° C. or as per required by the brand style. A foam measurement was recorded daily at 24-hour intervals to calculate the percentage (%) increase in foam height compared to a blank sample with no fermentation occurring where yeast is not added.

Results

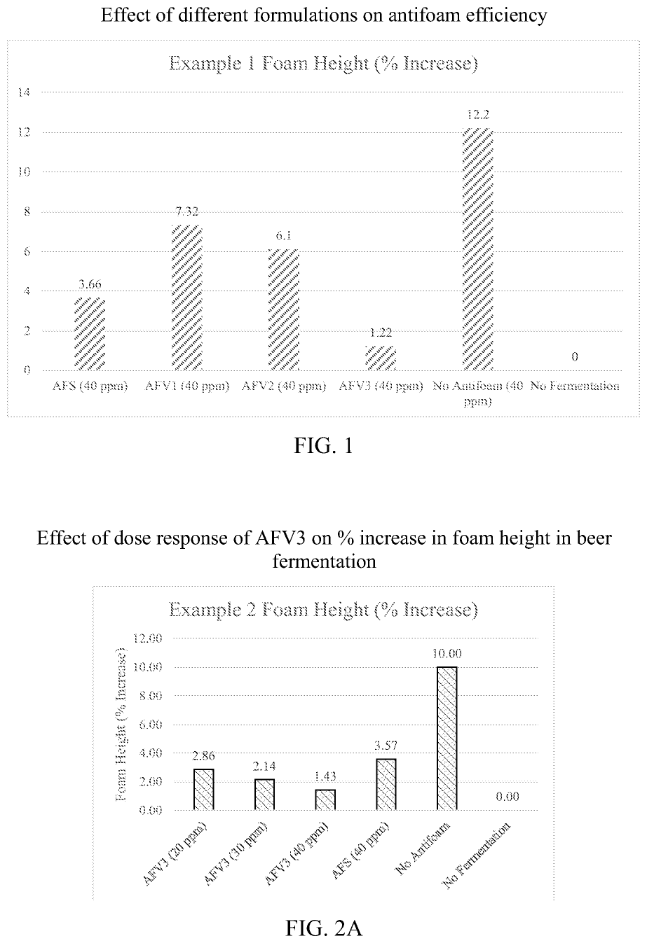

The results are shown in FIG. 1.

Among the different antifoams tested, AFV3 worked well compared with the silicone-based antifoam AFS. As noted above, AFV3 is the antifoam formulation based on rapeseed oil and other organic emulsifiers, and based on these results, AFV3 was chosen for further testing.

### Example 2

Example 2 shows the effects of dose optimization and foam stability in the finished beer.

### Methodology

Beer Preparation

Approximately 1.5 Kg of Amber malt extract was added to 8.5 L of water. The mixture was heated, 1.5 g/l of hops was added when the mixture started to boil, and a rolling boil was maintained for 45 minutes. Next, 1 whirlfloc Tablet was added 15 minutes before the boiling was stopped. The original gravity (OG) was then brought to about 1.045-1.050 using water or dextrose as required. Next, the wort was cooled using a heat exchanger and then hot break (proteins and polyphenols that coagulate during the wort boil) was separated by leaving the wort to settle for 20 minutes and decanting the clear wort. 700 ml of wort was then poured into graduated cylinders so that foam could be measured. Next, 250 g/hl of ale yeast Safale K-97 was added to each graduated cylinder, and the wort was allowed to ferment at RT for 4 to 5 days. Finally, the graduated cylinders were placed in a chilled incubator at 0.5° C. for 48 hours.

Filtration

Filtration is not particular limited, and of course, can be carried out as per the brand style in brewery. The following process was carried about for this test. 250 g/hl of filter aid was added into beer and mixed. Next, a filter unit was assembled (SARTOFLOW® Slice 200 Benchtop System) using a 0.45 μm PES filter membrane. Chilled water was recirculated at 2° C. around the filter unit jacket. The filter was precoated with 700 g/hl of filter aid in water. Next, chilled beer was poured into filter unit so that there is minimum disruption of filter precoat. The filter unit was then sealed and constant air pressure was applied. The filtered beer was then collected.

Carbonation and NIBEM Analysis

Beer was carbonated at a concentration of 5 g/l CO₂. Foam stability of finished beer was done using NIBEM equipment as per standard protocol.

Results

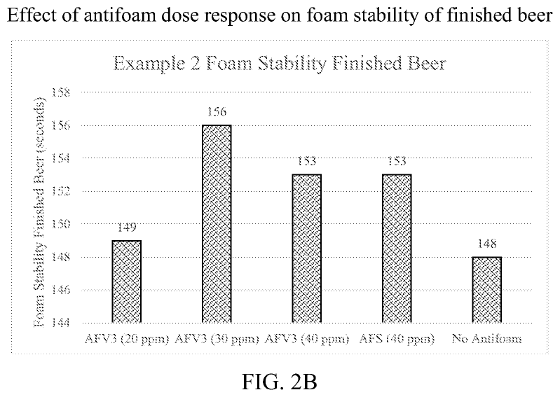

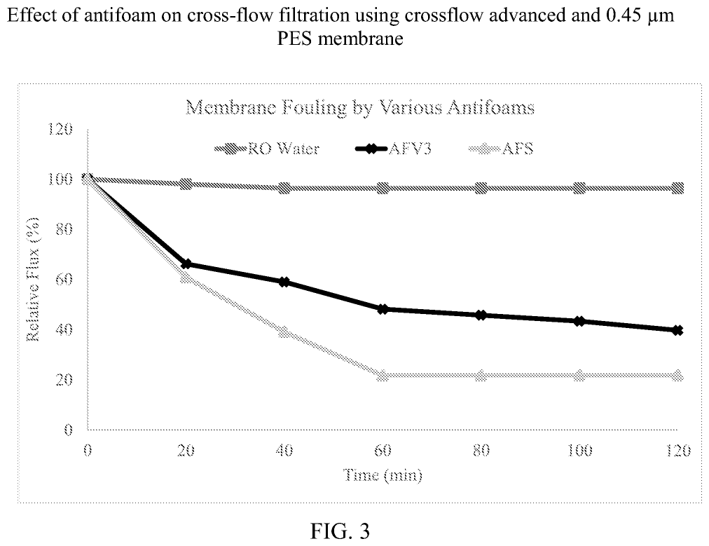

Based on the results from Example 1, AFV3 was chosen as an antifoam to conduct dose response curve (see FIG. 2A) and to measure foam stability in finished beer (see FIG. 2B). Based on the results, the use of AFV3 at 40 ppm was best suited to deliver antifoam efficiency, as well as preserve the foam stability in finished beer.

### Example 3

Example 3 shows the effects of beer with cross flow filtration.

Beer Preparation

Beer preparation was conducted using the same methodology described in Example 2.

Filtration

Filtration is not particular limited, and of course, can be carried out as per the brand style in brewery. Cross-flow filtration was carried out using Sartoflow Advanced equipment and a PES hollow fibre membrane of 0.45 μm porosity. The following beer sample protocol was used for the cross-flow filtration.

Sartorius Advanced with Hollow Fibre Membrane Sample Analysis Protocol

The reservoir tank was filed with 9 litres of sample using a peristaltic pump. The feed pump was started at a slow speed. The bypass valve was opened fully before starting the pump so that any air in system would not go into the column. The system was left to recirculate for 5 minutes at 5% pump speed to flush any air from system. The bypass valve was then slowly closed, and the pump speed was slowly increased so the feed and TMP=0.5-5 psig to wet the module and remove air from the system. The pinch valve on the retentate was used to generate back pressure and transmembrane pressure (TMP) to get permeate flow through the fibres. The pump speed was then slowly increased so the feed and TMP=0.5-5 psig thereby removing air from the system. The inlet pressure was slowly increased to 0.7 bar and a flux analysis was carried out. The Retentate flow rate (L/h), Permeate flow rate (L/h), Inlet Pressure (bar), DPRESS (bar), TMP (bar), and Diaphragm (% capacity) were recorded every 5 minutes.

The beer samples were dosed with the non-silicone antifoam AFV3 and the silicone antifoam AFS at 40 ppm each. Then they were filtered using above protocol, and the flux rate was measured in litres/hour.

Results

Based on the results from Example 1, AFV3 was chosen as the non-silicone antifoam and AFS as the silicone antifoam to compare efficiency of filtration and showcase filter blinding. Based on the results, AFV3 was shown to provide better filtration performance compared to AFS. AFV3 also showed faster filtration rate and slower blinding of the membrane and hence lower impact on the cross-flow filtration performance with 0.45 μm membrane.

While there have been shown and described fundamental novel features of the disclosure as applied to the preferred and exemplary embodiments thereof, it will be understood that omissions and substitutions and changes in the form and details of the disclosure may be made by those skilled in the art without departing from the spirit of the disclosure. Moreover, as is readily apparent, numerous modifications and changes may readily occur to those skilled in the art. For example, any feature(s) in one or more embodiments may be applicable and combined with one or more other embodiments. Hence, it is not desired to limit the present disclosure to the exact construction and operation shown and described and, accordingly, all suitable modification equivalents may be resorted to falling within the scope of the present disclosure as claimed. In other words, although the embodiments of the disclosure have been described with reference to the above examples, it will be understood that modifications and variations are encompassed within the spirit and scope of the disclosure. Accordingly, the invention is limited only by the following claims.

All references disclosed herein are hereby incorporated by reference in their entireties.

What is claimed is:

1. A method of processing a liquid, comprising:
adding an antifoam to a process liquid, and
after adding the antifoam, continuously feeding the process liquid through one or more cross-flow filter membrane configured for cross-flow filtration,
wherein the antifoam comprises a mixture of (A) a vegetable oil and (B) an organic emulsifier or surfactant.

2. The method according to claim 1, wherein purified liquid passes through the cross-flow filter membrane as filtrate, and solids suspended in the process liquid, which are too large to pass through pores of the cross-flow filter membrane, are retained in an increasingly concentrated retentate.

3. The method according to claim 1, wherein the process liquid is a liquid subject to excessive foaming during a liquid processing step.

4. The method according to claim 1, wherein the process liquid is a beverage.

5. The method according to claim 1, wherein the process liquid is beer or wine.

6. The method according to claim 1, wherein the process liquid is beer, and the antifoam is added during a step of wort boiling and/or during a step of fermentation.

7. The method according to claim 1, wherein 2 ppm to 500 ppm of the antifoam is added to the process liquid.

8. The method according to claim 1, wherein the cross-flow filter membrane is composed of a ceramic material or a polymeric material.

9. The method according to claim 1, wherein the cross-flow filter membrane is composed of polyethersulfone (PES), polysulfone (PS), modified polyethersulfone (mPES), mixed ester (ME), mixed cellulose ester (MCE), or blends thereof.

10. The method according to claim 1, wherein the cross-flow filter membrane is composed of polyethersulfone (PES).

11. The method according to claim 1, further comprising a step of reducing a temperature of the process liquid below a melting point of the vegetable oil of the antifoam.

12. The method according to claim 1, further comprising a step of allowing the antifoam to at least partially solidify prior continuously feeding the process liquid through the one or more cross-flow filter membrane.

13. The method according to claim 1, wherein the vegetable oil is one or more selected from the group consisting of soybean oil, palm oil, rice bran oil, sunflower oil, olive oil, coconut oil, rapeseed oil, canola oil, peanut oil, cottonseed oil, corn oil, linseed oil, safflower oil, sesame oil, hazelnut oil, açaí palm oil, avocado oil, brazil nut oil, cashew oil, chia seed oil, cocoa butter oil, flaxseed oil, hemp seed oil, pecan oil, and walnut oil.

14. The method according to claim 1, wherein the organic emulsifier or surfactant is one or more selected from the group consisting of mustard, soy and egg lecithin, mono- and diglycerides, polysorbates, carrageenan, guar gum, polyglycerol esters, stearoyl lactylates, propylene glycol, propylene glycol esters, sucrose esters, saccharide fatty acid esters, milk proteins, wheat glutens, gelatins, prolamines, soy protein isolates, starches, acetylated polysaccharides, alginates, carrageenans, chitosans, inulins, long chain fatty acids, waxes, agar, alginates, glycerol, gums, poloxamers, monosodium phosphates, monostearate, fatty acid methyl esters (e.g., methyl stearate, methyl palmitate, methyl palmitoleate (cis-9)), and blends thereof. Specific examples include, for example, sorbitan monododecanoate, polyoxyethylene 20 sorbitan monostearate, sorbitan mono-9-octadecenoate, and 9-octadecenoic acid.

15. The method according to claim 1, wherein the antifoam further comprises hydrophobic silica and/or hydrophilic silica.

16. The method according to claim 1, wherein the vegetable oil includes rapeseed oil, and
the organic emulsifier or surfactant includes one or more selected from the group consisting of sorbitan monododecanoate, polyoxyethylene 20 sorbitan monostearate, sorbitan mono-9-octadecenoate, and 9-octadecenoic acid.

17. The method of claim 1, wherein a weight ratio of the vegetable oil in the antifoam is from 5.0 to 70.0 wt %; and a weight ratio of the organic emulsifier or surfactant in the antifoam is from 5.0 to 60.0 wt %.

18. The method of claim 16, wherein a weight ratio of the vegetable oil in the antifoam is from 5.0 to 70.0 wt %; and a weight ratio of the organic emulsifier or surfactant in the antifoam is from 5.0 to 60.0 wt %.

19. The method of claim 1, wherein silica is not included in the antifoam

20. The method of claim 1, wherein silicone is not included in the antifoam.
